(19) United States
(12) Patent Application Publication
(10) Pub. No.: US 2023/0166936 A1
(43) Pub. Date: Jun. 1, 2023

(54) BELT FOR CONVEYOR HAVING PERFORATED AREAS

(71) Applicant: BRICQ, MONTBRON (FR)

(72) Inventor: Philippe Ramirez, ALISSAS (FR)

(21) Appl. No.: 17/905,931

(22) PCT Filed: Mar. 10, 2021
(86) PCT No.: PCT/EP2021/055969

§ 371 Date: Sep. 8, 2022

(30) Foreign Application Priority Data
Mar. 11, 2020 (FR) 20 02403

(51) Int. Cl. B65H 29/24

(52) U.S. Cl. CPC B65H 29/242; B65H 2701/1762; B65H 2406/32231; B65H 2404/27

(57) ABSTRACT

The present invention relates to a belt for a conveyor. The belt comprises at least one perforated area (24), the belt (14) having openings (28) in the or each perforated area (24) so that the belt is permeable to air in the perforated area (24).

The present invention relates to a belt for a conveyor.

Such a belt is used in a conveyor belt. The belt is, for example, driven in the conveyor by means of at least one drive roller.

Such a belt is, for example, used in a machine for the manufacture of corrugated cardboard.

In FR 3 046 997 A1, the corrugated cardboard is driven between two conveyor belts in the pulling part. The cardboard is thus pulled by a lower and an upper belt.

The presence of two conveyor belts allows the cardboard to be clamped between the two belts, in particular to keep the cardboard in contact with the belts to facilitate the transport of the cardboard.

However, the two conveyor belts are cumbersome.

The presence of two conveyors also means a higher production cost for the machine and a more complex machine with higher maintenance.

It is therefore an object of the invention to enable the simplification of such a machine adapted to drive cardboard.

To this end, the invention relates to a conveyor belt of the aforementioned type, wherein the belt comprises at least one perforated area, the belt having openings in the or each perforated area so that the belt is permeable to air in the perforated area.

The presence of at least one perforated area in the belt provides the possibility of providing a suction or negative-pressure table on one side of the belt so as to press the conveyed object, such as cardboard, on the opposite side of the belt against the belt, With the object pressed against the belt, it is pulled along by the belt with a good hold.

The belt according to the invention may comprise one or more of the following features, taken alone or in any combination that is technically possible:
the belt comprises at least one solid area, the belt being free of openings in the or each solid area;
the belt comprises a plurality of perforated areas and a plurality of solid areas, the belt being intended to be moved in a direction of travel in a conveyor, the perforated areas and the solid areas being placed alternately along a transverse direction, the transverse direction being arranged to be perpendicular to the direction of travel;
the belt comprises a woven structure, the woven structure extending over the entire belt;
the belt has a drive face intended to mate with a drive device and a conveying face intended to mate with an object to be moved, the woven structure having a treatment to increase the coefficient of friction, more particularly being coated or impregnated with a silicone-based product, at least on the conveying face in the whole of the or each solid area;
the perforated woven structure is free of silicone or silicone-based products on the drive face;
the woven structure has a tighter weave in the solid area(s) than in the perforated area(s);
the woven structure comprises main warp threads and secondary warp threads, the main warp threads being similarly woven in the solid area(s) and in the perforated area(s), the distribution density of the secondary warp threads being strictly lower in the perforated area(s) than in the solid area(s);
the main warp threads are made of synthetic and/or natural materials;
the belt is free of silicone or silicone-based products in the or each perforated area.

The invention will be better understood upon reading the following description, given only as an example, and with reference to the attached drawings, in which:

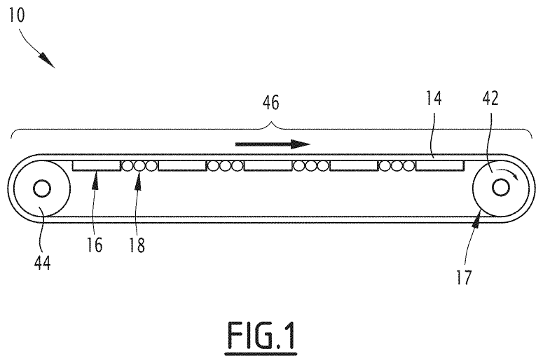

FIG. 1 is a schematic view of a conveyor,

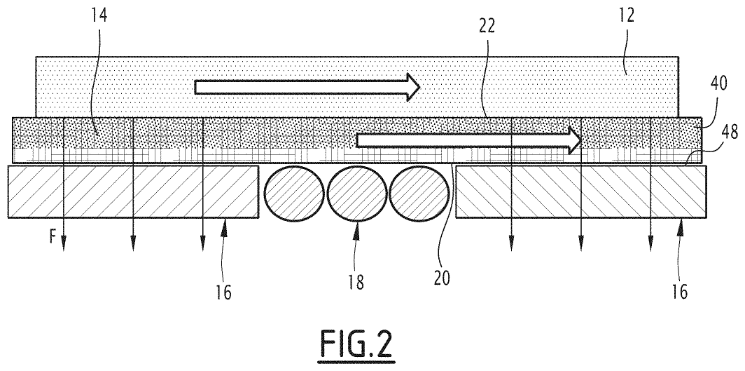

FIG. 2 is a schematic view of part of a conveyor comprising a belt according to one embodiment of the invention,

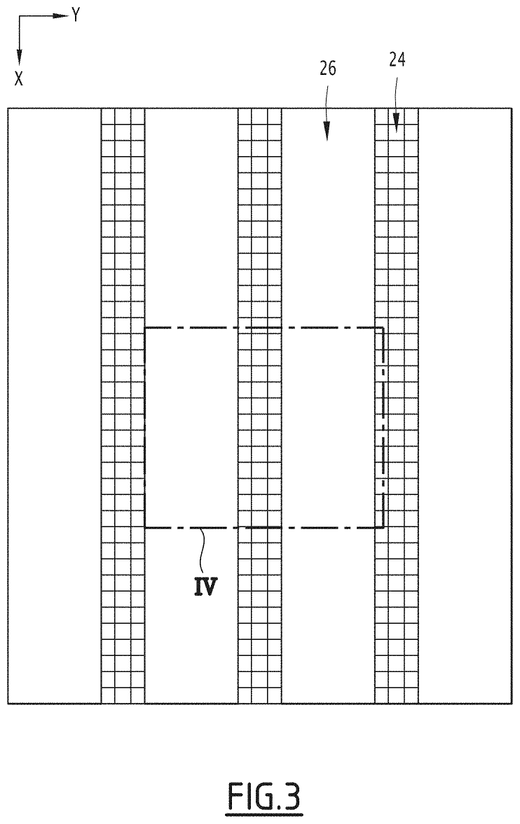

FIG. 3 is a schematic top view of a belt according to one embodiment of the invention, and

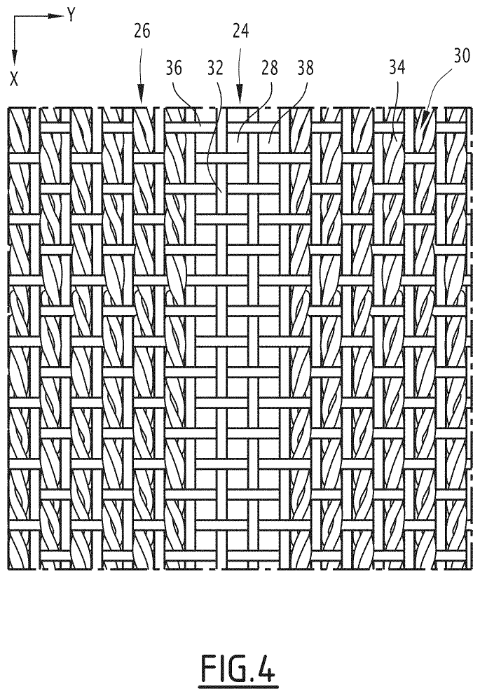

FIG. 4 is a schematic view of zone IV of FIG. 3.

A conveyor 10 intended to transport an object 12 is depicted in FIGS. 1 and 2. The object 12 is, for example, cardboard, more particularly corrugated cardboard.

The conveyor 10 comprises a belt 14 according to the invention and at least one suction or negative-pressure table, called a vacuum table 16.

The conveyor 10 comprises a drive device 17 and advantageously a transmission device 18.

The belt 14 is depicted in FIGS. 3 and 4.

The belt 14 extends mainly along a longitudinal direction X and a transverse direction Y perpendicular to the longitudinal direction X.

The belt 14 is intended to be moved in the conveyor along the longitudinal direction X.

The belt 14 has a thickness in a direction perpendicular to the longitudinal X and transverse Y directions.

The belt 14 is flexible. The belt 14 is, for example, adapted to be partially wound around a drive roller.

The belt 14 is substantially rectangular in shape, having sides in the longitudinal direction X and sides in the transverse direction Y.

The belt 14 has a drive face 20 intended to mate with the drive device 17 and a conveyor face 22 intended to mate with the object 12.

The belt 14 comprises at least one perforated area 24 and, in the embodiment shown, at least one solid area 26.

More particularly, the belt 14 comprises a plurality of perforated areas and a plurality of solid areas.

The ratio of the total surface area of all solid areas to the total surface area of all perforated areas is between 1% and 50%.

The perforated areas 24 and the solid areas 26 are placed in alternating fashion along the transverse direction Y.

The perforated areas 24 and the solid areas 26 each have their own general shape.

In the example shown, each of the perforated areas 24 and each of the solid areas is generally rectangular in shape. One side of each general rectangular shape extends in the longitudinal direction X and another side extends in the transverse direction Y.

Each of the perforated areas 24 and each of the solid areas 26 extends along the entire length of the belt 14 in the longitudinal direction X.

The perforated areas 24 have the same dimension as one another in the transverse direction Y.

The solid areas 26 have the same dimension as one another in the transverse direction Y.

The ratio of the dimension in the transverse direction Y, known as the width, of a solid area to the width of a perforated area is between 1% and 50%.

A solid area is arranged at each end of the belt in the transverse direction Y.

The belt 14 has openings 28 in the or each perforated area 24, so that the belt 14 is air-permeable in the perforated area 24.

The ratio of the total surface area of the openings 28 in a perforated area to the total surface area of the corresponding perforated area 24 is between 30% and 80%.

The belt 14 is configured so that a pressure difference between the drive face 20 and the conveyor face 22 at the perforated area 24 causes an application force F to be applied to the conveyor face 22.

The pressure is higher in the environment of the conveyor face 22 than in the environment of the drive face 20, so that the application force F is directed from the conveyor face 22 to the drive face 20.

In particular, the object 12 can be held against the conveying surface 22 near the perforated areas 24.

The openings further allow for permeability of the belt, particularly to allow the escape of material such as liquid, especially if the object 12 is drying cardboard.

The openings in the or each perforated area have a size between 0.1 mm and 5 mm.

The openings are distributed in the perforated area with a density of between 30% and 80%.

The belt 14 has no openings in the or each solid area 26.

The belt 14 is airtight in the or each solid area 26.

The belt 14 comprises a woven structure 30.

The woven structure 30 extends over the entire belt, more particularly over the entire surface of the belt in the longitudinal X and transverse Y directions.

The woven structure 30 has a tighter weave in the solid area(s) 26 than in the perforated area(s) 24.

The woven structure 30 comprises warp threads 32, 34, more particularly main warp threads 32 and secondary warp threads 34, and weft threads 36.

The weft threads 36 extend over the entire surface of the woven structure 30 and are woven evenly over the entirety of said surface.

Each weft thread 36 here is monofilament.

They are, for example, made of polyester.

The main weft threads 32 extend over the entire surface of the woven structure 30 and are woven evenly over the entirety of said surface.

The main warp threads 32 are similarly woven in the solid area(s) 26 and in the perforated area(s) 24.

The main warp threads 32 are made of synthetic and/or natural materials.

Each main warp thread 32 is monofilament.

They are, for example, made of polyester.

The main warp threads 32 and the weft threads 36 define spaces 38 between them.

The distribution density of the secondary warp threads 34 is strictly lower in the perforated zone(s) 24 than in the solid zone(s) 26.

In the example shown, the woven structure in the perforated areas 24 is free of secondary warp threads 34. The distribution density of the secondary warp threads 34 is then zero.

The openings 28 in the perforated areas correspond to the spaces between the main warp threads 32 and the weft threads 36.

The secondary warp threads 34 fill the spaces 38 defined by the weave between the weft threads 36 and the main warp threads 32 in the solid areas.

Each secondary warp thread 34 is multi-filament

The secondary warp threads 34 are, for example, made of synthetic and/or natural material.

The woven structure in the perforated areas 24 is identical to the woven structure in the solid areas 26, except that the woven structure is free of secondary warp threads 34 in the perforated areas.

The woven structure in the solid areas 26 corresponds, for example, to the fabric BRICQ-SPEED© marketed by BRICQ©.

A treatment is applied to the woven structure 30 at least on the conveyor face 22 in all the or each solid area 26, the treatment allowing the coefficient of friction to be increased.

The woven structure 30 is, for example, coated or impregnated with a silicone-based product 40 at least on the conveying face 22 in all the or each solid area 26.

Such a product 40 comprises, for example, at least 10% silicone

Such a product 40 comprises, for example, a silicone base and cross-linking agents, among others.

In particular, this allows for a better grip between the object 12 and the conveyor face 22.

More particularly, in all the or each solid area 26, the woven structure 30 is coated or impregnated with silicone-based product 40 throughout the thickness of the belt 14 except for the drive face 20.

In particular, this prevents air from flowing into the solid area 26 through its thickness, so that negative air pressure between the drive face 20 and the conveyor face 22 results in a holding force against the conveyor face 22 concentrated at the perforated areas, so that the force is locally greater than if the belt were configured such that air at the perforated areas was likely to enter the thickness of the solid area(s).

The drive face 20 is free of any treatment intended to increase the coefficient of friction, such as a silicone-based coating.

A treatment is, for example, applied to the drive face 20 to reduce its coefficient of friction.

This reduces the friction between the drive face 20 of the belt 14 and the drive device and/or the vacuum table and/or the transmission device, and thus the energy required for the belt 14 to be driven by the drive device.

The belt 14 is furthermore free of silicone or silicone-based products in the or each perforated area 24.

This allows air to circulate through the openings 28.

The belt 14 is arranged on the drive device 17 so as to be driven in a direction of travel.

The drive device 17 here comprises at least one drive roller 42.

The drive device 17 further comprises a tensioning roller 44.

The rollers 42, 44 are arranged on either side of the conveyor 10 in the direction of travel.

The drive roller 42 is arranged at a downstream end of the conveyor 10 and the tensioning roller 44 at an upstream end.

The drive roller 42 is adapted to be rotated about an axis perpendicular to the direction of travel, for example by a motor.

The belt 14 surrounds the drive roller 42 and the tensioning roller 44 and connects them.

Between the drive roller 42 and the tensioning roller 44, the longitudinal direction X of the belt is arranged parallel to the direction of travel.

The belt 14 then has a conveying portion 46, the conveying portion 46 corresponding to the area of the belt 14 that at a given time is usable for conveying an object 12.

An object 12 resting on the conveyor face 22 of the convoying portion 46 is here located above the conveyor face 22 on which it rests according to the vertical of the location.

The conveyor 10 here comprises a plurality of vacuum tables 16 arranged along the direction of travel.

In particular, the vacuum tables 16 are arranged opposite the conveyor portion 46 of the belt 14.

In one embodiment, the vacuum tables 16 are arranged at regular intervals. The intervals between the belts are, for instance, comprised between 5 mm and 800 mm.

The vacuum tables 16 are arranged symmetrically with respect to the centre of the table in the longitudinal direction X, the axis of symmetry being parallel to the transverse direction Y.

Each vacuum table comprises at least one vacuum surface 48 arranged facing the belt 14, more particularly the conveyor portion 46.

Each vacuum table 16 here extends over the entire dimension in the transverse direction Y of the belt 14.

Alternatively, the conveyor 10 comprises a plurality of vacuum tables 16 along the transverse direction Y of the belt 14, the vacuum tables 16 extending opposite the perforated areas 24.

Each vacuum table generates a local negative air pressure at the vacuum surface 48.

The conveyor 10 here comprises a plurality of transmission devices 18 arranged along the direction of travel.

In particular, the transmission devices 18 are arranged facing the conveyor portion 46 of the belt 14.

The transmission devices 18 are arranged between the vacuum tables 16.

The transmission devices 18 are, for example, rollers.

The transmission devices 18 are able to move the belt 14 on the conveyor 10 in the direction of travel.

In one embodiment, the conveyor 10 further comprises at least one heating table facing the conveyor portion 46 of the belt 14.

In particular, this allows a piece of cardboard on the belt 14 to be dried if it is too wet.

The conveyor does not have a second conveyor belt arranged facing the belt 14 facing away from the object 12.

The operation of a conveyor 10 as described above will now be described.

The belt 14 is driven in the direction of travel by the drive device 17.

The vacuum table(s) 16 generate localized negative pressure.

In the perforated areas, the local negative pressure of each vacuum table 16 causes a force to be applied to any object 12 on the conveyor face 22 opposite the vacuum table 16 through the openings 28.

The object 12 is in this case cardboard extending over the entire conveyor portion 46 of the belt 14 along the direction of travel.

The cardboard is therefore held flat against the conveyor face 22 opposite the perforated areas throughout its travel on the conveyor section 46, without the need for a second conveyor belt opposite the belt to clamp the object between the two belts.

Here the object 12 has a face extending against the conveyor face 22 and an opposite face.

The opposite side is exposed to the surrounding air.

When the object 12 is high moisture content cardboard, the exposed side allows for improved moisture evaporation.

The high moisture content cardboard is, for example, a corrugated cardboard comprising two flat sheets of paper with a corrugated sheet of paper between them which have just been glued together.

The heating table, if there is one, dries the board so as to increase the rate at which its moisture content is reduced.

A belt according to the invention thus makes it possible, on the one hand, to offer the possibility of holding an object on the conveying side by applying a negative pressure to the drive face and, on the other hand, to improve the evaporation of any excess moisture from an object on the conveying side, as the object is not clamped between two conveyor belts but has an exposed side.

1. A belt for a conveyor, the belt comprising at least one perforated area, the belt having openings in the or each perforated area so that the belt is permeable to air in the perforated area.

2. The belt according to claim 1 comprising at least one solid area, the belt being free of openings in the or each solid area.

3. The belt according to claim 2, comprising a plurality of perforated areas and a plurality of solid areas, the belt being intended to be moved in a direction of travel in a conveyor, the perforated areas and the solid areas being placed alternately along a transverse direction, the transverse direction being arranged to be perpendicular to the direction of travel.

4. The belt according to claim 1, wherein the belt comprises a woven structure, the woven structure extending over the entire belt.

5. The belt according to claim 4, wherein the belt comprises at least one solid area, the belt being free of openings in the or each solid area, and wherein the belt has a drive face adapted to mate with a drive device and a conveyor face adapted to mate with an object to be moved, the woven structure having a treatment to increase the coefficient of friction, more particularly being coated or impregnated with a silicone-based product, at least on the conveyor face in all the or each solid area.

6. The belt according to claim 5, wherein the woven structure is free of silicone or silicone-based products on the drive face.

7. The belt according to claim 4, wherein the woven structure has a tighter weave in the solid area or areas than in the perforated area or areas.

8. The belt according to claim 4, wherein the woven structure comprises main warp threads and secondary warp threads, the main warp threads being similarly woven in the solid area(s) and in the perforated area(s), the distribution density of the secondary warp threads being strictly lower in the perforated area(s) than in the solid area(s).

9. The belt according to claim 8, wherein the main warp threads are made of synthetic and/or natural materials.

10. The belt according to claim 1, wherein the belt is free of silicone or silicone-based products in the or each perforated area.
